(19) United States
(12) Patent Application Publication
(10) Pub. No.: US 2026/0018011 A1
(43) Pub. Date: Jan. 15, 2026

(54) Automated Pizza Dispensing System and Method

(71) Applicant: Farshid Asvadi, Torrance, CA (US)

(72) Inventor: Farshid Asvadi, Torrance, CA (US)

(21) Appl. No.: 18/769,356

(22) Filed: Jul. 10, 2024

(51) Int. Cl. G07F 11/62; A21C 9/08; A21D 13/41; A23L 5/10; G06Q 20/18

(52) U.S. Cl. CPC G07F 11/62; A21C 9/08; A21D 13/41; A23L 5/15; G06Q 20/18

(57) ABSTRACT

An automated pizza dispensing system designed to simplify the process of storing, cooking, and delivering pizzas while minimizing mechanical complexity and maintenance costs. The system features a cylindrical storage structure housing plurality of multi-channel racks capable of holding pizzas in a freezer environment. A standard LCD payment and ordering system allows customers to select their desired product, which is then retrieved by a self-contained robotic fork and delivered to an oven. The oven cooks the product using a combination of microwave, impingement and infrared heating methods. After cooking, the product is transferred to a serving tray and delivered to the customer through a front delivery window. The system's design maximizes storage capacity, reduces the need for complex servos and PLCs, and ensures efficient and quick delivery of high-quality pizzas.

### CROSS-REFERENCE TO RELATED APPLICATIONS

No related applications are previously filed.

### FIELD OF THE INVENTION

The present invention relates to automated dispensing machines, and more specifically, to an automated pizza dispensing system designed to simplify the mechanical complexity, reduce manufacturing costs, and enhance the reliability and quality of the final product.

### BACKGROUND OF THE INVENTION

Pizza vending and/or dispensing machines have been available for several years, primarily imported from Italy and Asia. These machines provide the convenience of delivering hot pizzas and similar products 24/7 within a short time frame of 3-4 minutes. They are advantageous in reducing labor costs, requiring minimal space, and being suitable for high-traffic areas such as hotels and shopping centers. Automated pizza vending machines have been developed to provide consumers with convenient access to hot, ready-to-eat pizza at any time of the day. These machines are particularly beneficial in high-traffic areas where quick service and minimal labor are critical. However, the reception of these machines has been lukewarm due to their complex designs and high manufacturing costs. Existing pizza vending machines face several challenges that have hindered their widespread acceptance and deployment.

One notable example of prior art is KR20010058040A, which discloses a pizza vending machine designed to provide various kinds of pizza conveniently. This machine uses a selection button to withdraw and discharge pizza packages, regulated by a solenoid valve and an interrupter. Despite its functional design, KR20010058040A suffers from mechanical complexity and potential reliability issues due to its reliance on multiple moving parts and solenoid-based control mechanisms.

Another example, US20110059209A1, describes an apparatus and method for preparing and cooking pizza using fresh ingredients in a vending machine format. This machine includes a refrigerated section for ingredient storage, an oven for cooking, and a boxing mechanism for delivery. While US20110059209A1 addresses the freshness of ingredients and customization of pizzas, its design involves numerous components such as dough slicing, sauce dispensing, and cheese application mechanisms, leading to increased complexity and higher maintenance requirements.

U.S. Pat. No. 8,710,408B2 builds on US20110059209A1 by providing an automated pizza preparation and vending system with enhanced features such as dough slicing, defrosting, topping application, and packaging. The system employs multiple processors to monitor and control the process, ensuring proper temperature management and precise operation. However, the intricate design and dependence on multiple processors contribute to higher manufacturing costs and potential points of failure.

U.S. Pat. No. 11,178,879B2 introduces a vehicle-based automated pizza-making system with a two-piece pizza pan conveyed on pan drive rails. The system aims to improve positional control and accuracy during pizza preparation. Despite its innovative approach, U.S. Pat. No. 11,178,879B2's complexity and reliance on timing belts and rails add to the overall cost and maintenance challenges.

The primary obstacles in the field of automated pizza vending machines include mechanical complexity, high manufacturing costs, reliability and maintenance issues, and challenges in achieving high product quality. Existing designs often involve numerous moving parts, intricate control mechanisms, and multiple processors, leading to increased likelihood of mechanical failures and higher maintenance costs. The complexity and number of components required in traditional designs contribute to elevated production expenses, limiting the affordability and commercial viability of these machines. The dependence on complex mechanical and electronic systems results in frequent downtime and expensive repairs, reducing the overall reliability of the machines. Finally, achieving a product quality comparable to commercially prepared pizza remains a challenge, particularly with regard to even cooking and freshness of ingredients.

These and many other problems have been long identified. Different solutions to the problems have been tried. However there exists no comprehensive solution to all the above problems. Therefore, the objective of the present invention overcomes the limitations and drawbacks from the prior art. To achieve above and other objectives, the present invention anticipates a new and entirely different system and method that resolves the limitations and drawbacks.

The present invention aims to overcome these challenges by introducing an automated pizza vending system that combines simple mechanical movements with advanced robotic technology. This design ensures reliability, ease of maintenance, and cost-effectiveness while delivering high-quality pizza quickly and efficiently.

Key innovations and advantages of the invention include a simplified mechanical design, robotic product handling, an advanced cooking system, and an efficient delivery mechanism. The invention employees a cylindrical storage structure with plurality of multi-channel racks, each capable of holding a substantial number of pizzas or similar products in a freezer environment. This streamlined design reduces the need for complex control mechanisms and minimizes potential points of failure. A self-contained robotic fork is used for product retrieval and delivery, eliminating the need for intricate servos and PLCs. The robotic fork follows a preset path, ensuring precise and reliable movement of the product. The oven utilizes microwave, impingement and infrared heating methods to ensure rapid defrosting and even cooking, resulting in a high-quality product comparable to commercially prepared pizza. The system includes a serving tray mechanism for ease of handling and a delivery conveyor that ensures the cooked product is delivered to the customer efficiently. The front delivery window opens and closes automatically, maintaining the internal environment of the system. By simplifying the mechanical design and reducing the number of components, the invention significantly lowers manufacturing costs, making it more commercially viable.

The present invention distinguishes itself from the prior art through several novel and inventive aspects. Unlike traditional machines that use horizontal or vertical shelving systems, the cylindrical structure maximizes storage capacity within a minimal footprint, optimizing space utilization. The unique nesting format of the pans eliminates the need for additional coverings, reducing costs and simplifying the design. The use of a self-contained robotic fork for product handling is a significant departure from complex servo-based systems, enhancing reliability and reducing maintenance requirements. The combination of impingement and infrared heating ensures that the product is cooked evenly and quickly, providing a high-quality result that meets consumer expectations. The integrated serving tray mechanism and delivery conveyor streamline the product delivery process, improving efficiency and customer satisfaction.

By addressing the mechanical complexity, high manufacturing costs, and reliability issues inherent in existing designs, the present invention offers a robust solution that meets the needs of both machine operators and consumers. The simplified design, coupled with advanced robotic and heating technologies, ensures a reliable, cost-effective, and high-quality pizza dispensing system suitable for various commercial applications.

### SUMMARY OF THE INVENTION

Embodiments of the invention solve the above-mentioned problems by providing an automated pizza dispensing system designed to simplify the process of storing, cooking, and delivering pizzas while minimizing mechanical complexity and maintenance costs. The invention leverages a combination of simple mechanical movements and advanced robotic technology to provide a reliable and efficient solution for dispensing high-quality pizzas.

In one aspect, the automated pizza dispensing system comprises a cylindrical storage structure housing a plurality of racks, each rack capable of holding a plurality of pizzas or other products in a freezer environment. The cylindrical design maximizes storage capacity within a minimal footprint.

In another aspect, the system includes a standard LCD payment and ordering system that allows customers to select their desired product. The ordering system is connected to a central processing unit (CPU) that manages the selection process and initiates the selection and the cooking cycle based on the customer's input.

In a further aspect, the product retrieval mechanism comprises a self-contained robotic fork configured to grab the selected product and deliver it to an oven. The designated multi-channel rack is positioned under an opening that leads to the upper cooking and serving section, where a flap opens to allow the rack to pass through. The robotic fork follows a preset path to deliver the product to the oven.

In yet another aspect, the oven is configured to cook the product using a combination of microwave, impingement and infrared heating methods. The oven includes a defrosting cycle to prepare the product before applying intense heat, ensuring that the product is cooked evenly and quickly.

In an additional aspect, the product delivery mechanism includes a serving tray mechanism and a delivery conveyor. After the cooking cycle, the robotic fork extracts the cooked product from the oven and moves it towards the delivery conveyor. The serving tray mechanism drops a serving tray onto the delivery conveyor before the robotic fork places the hot product into the tray. The delivery conveyor then moves the ready product towards the front delivery window.

In another preferred aspect, the front delivery window features a mechanical platform that rises to present the finished product to the customer. The platform retracts after the product is retrieved, and the access door closes to maintain the internal environment of the system. The delivery window is designed to open and close automatically, ensuring a seamless and hygienic delivery process.

In a further aspect, the system is designed for easy loading and maintenance. Parbaked products can be loaded into the system through an opening provided in the front side of the automated pizza dispensing system. The serving plate attachment can be detached, filled, and reattached with minimal effort. The use of simple mechanical movements and readily available robotic components ensures that the system is easy to service and maintain.

The present invention addresses the complexity and mechanical failures associated with existing pizza dispensing systems by implementing a simplified design. The use of a robotic arm eliminates the need for complex servos and programmable logic controllers (PLCs), reducing replacement costs and downtime. The cylindrical design and nesting format of the pans allow for maximum product storage within a minimal footprint, eliminating the need for cumbersome product coverings and reducing associated costs and additional components.

By leveraging simple mechanical movements and advanced robotic technology, the invention provides a cost-effective and reliable solution for dispensing high-quality pizzas. The combination of microwave, impingement and infrared heating methods ensures that the product is cooked evenly and quickly, while the user-friendly LCD payment and ordering system makes the ordering process simple and efficient. The innovative features and advantages of the invention make it a reliable and cost-effective solution for automated pizza dispensing.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 provides a perspective view of the automated pizza dispensing system further visualising the key exterior elements of the system.

FIG. 2 provides an internal perspective view of the automated pizza dispensing system further visualising the key interior and exterior elements of the system.

FIG. 3 provides a top perspective view of the automated pizza dispensing system further visualising the key elements provided in the upper cooking and serving section of the system.

FIG. 4 provides a top perspective view of the automated pizza dispensing system further visualising a focused view of the pizza or food delivery module of the system.

FIG. 5 provides an internal perspective view of the automated pizza dispensing system further visualising the five racks housed in the system in their respective locations.

### DETAILED DESCRIPTION OF PREFERRED EMBODIMENT(S)

The following detailed description is intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

The present invention relates to an automated pizza dispensing system designed to simplify the process of storing, cooking, and delivering pizzas while minimizing mechanical complexity and maintenance costs. The invention leverages a combination of simple mechanical movements and advanced robotic technology to provide a reliable and efficient solution for dispensing high-quality pizzas.

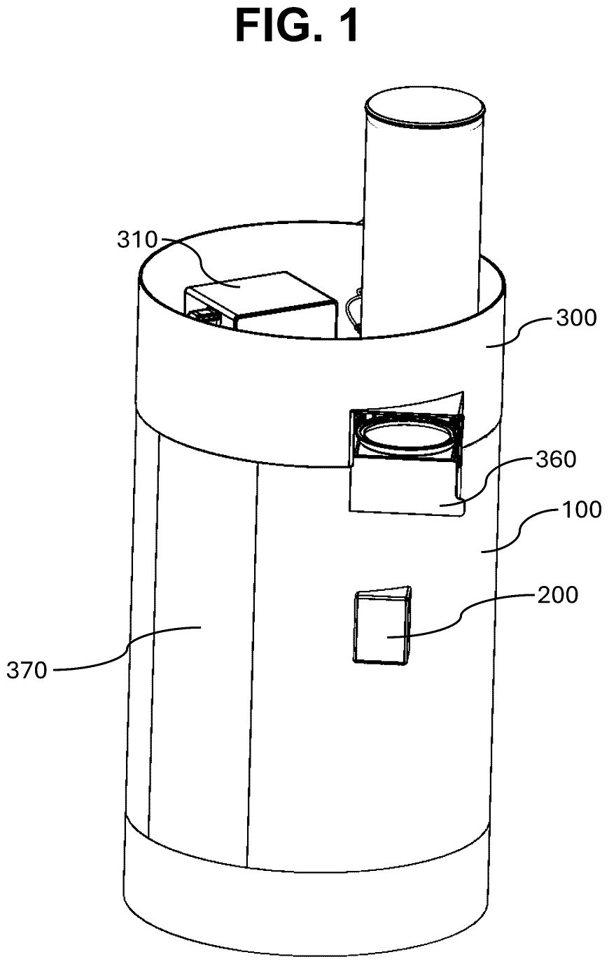

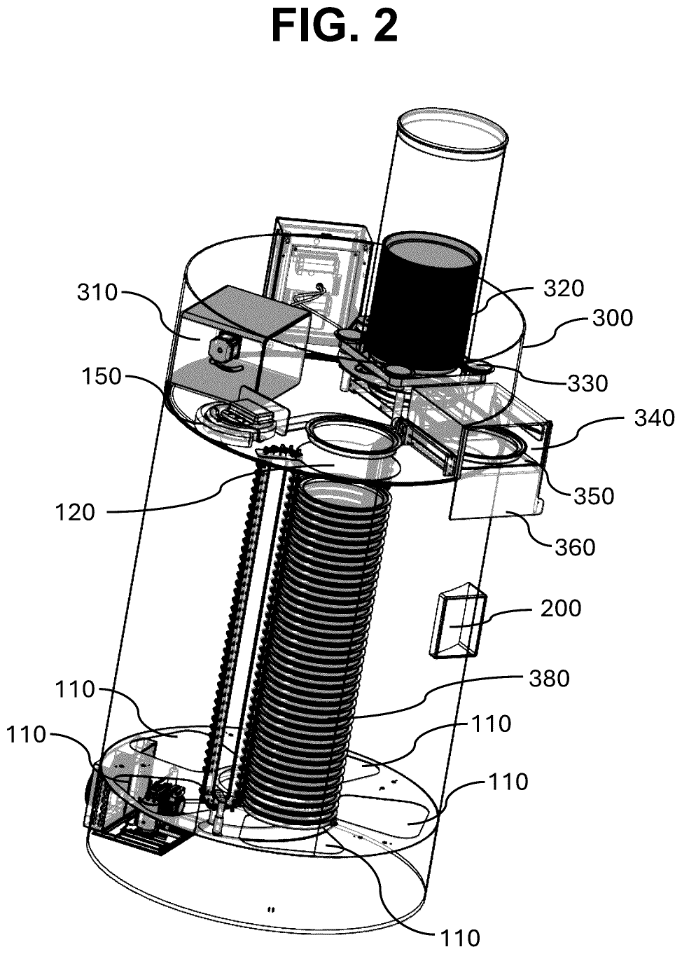

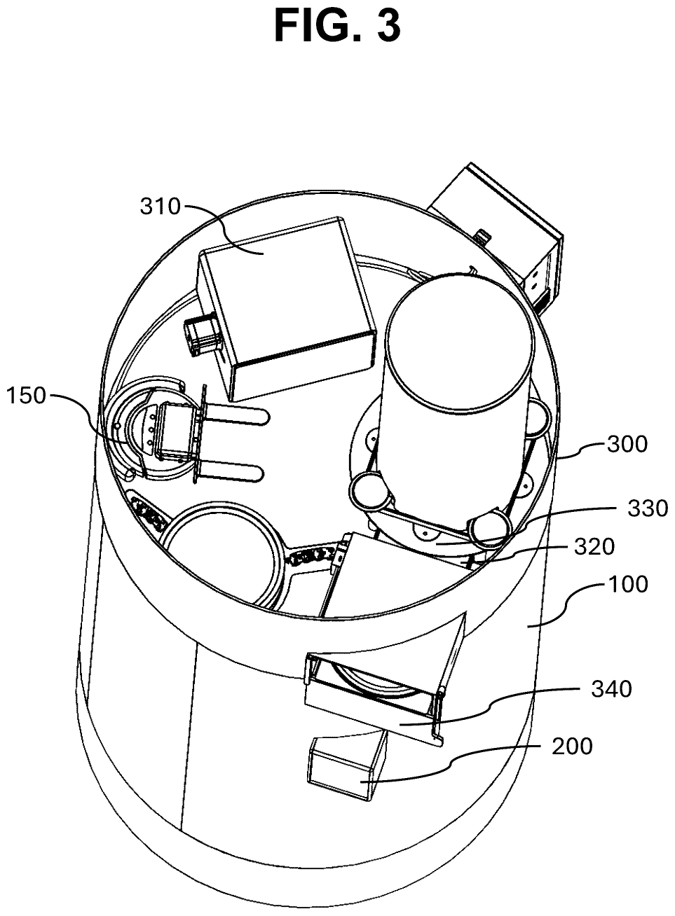

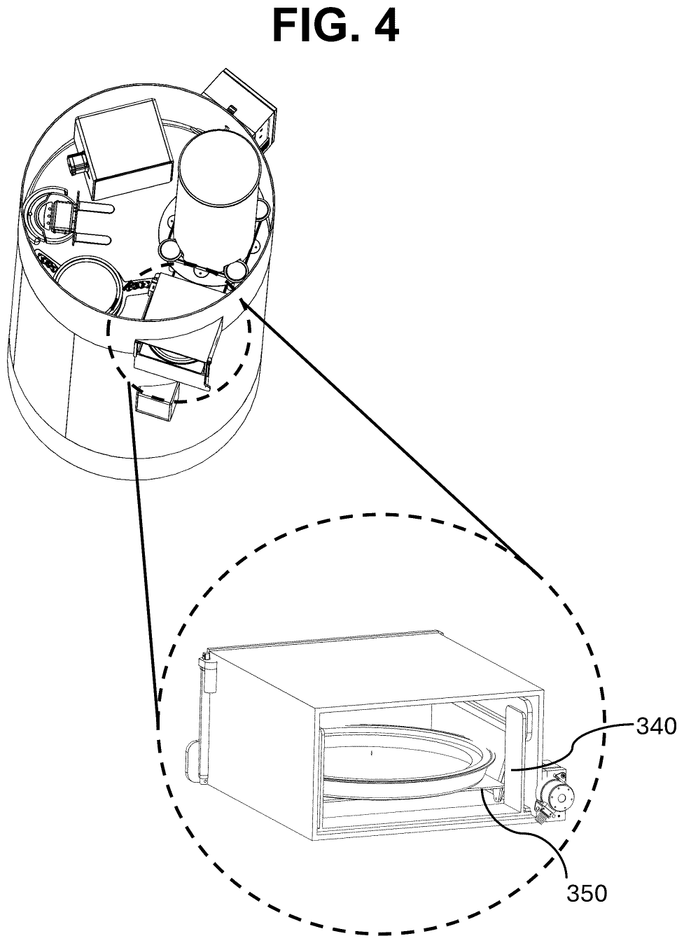

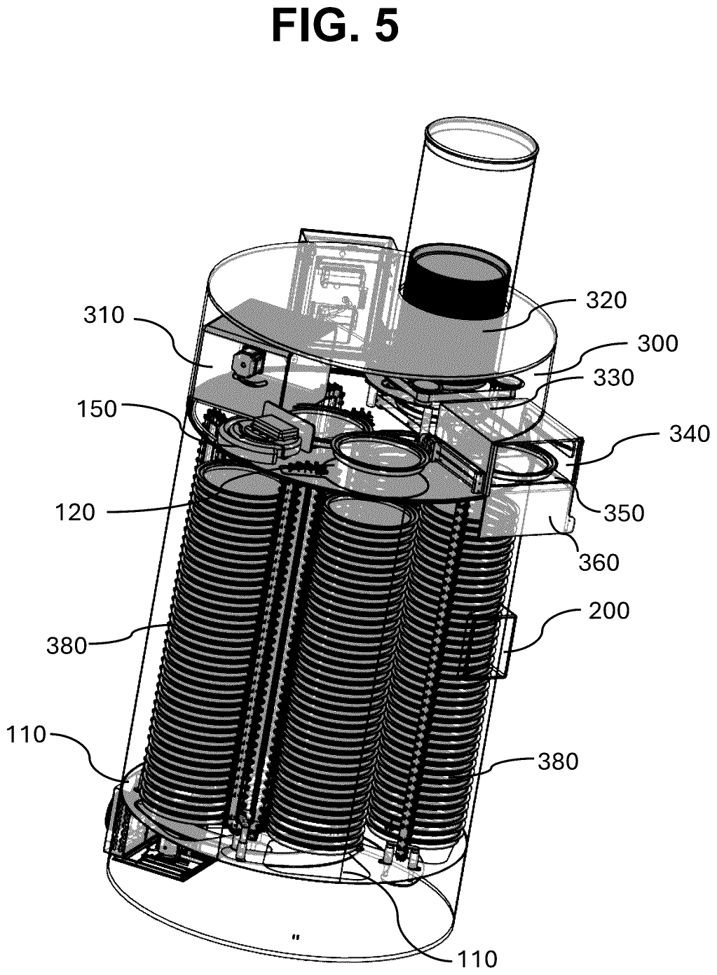

In a preferred embodiment of the present invention, the automated pizza dispensing system as visualised in FIG. 1 to FIG. 5 comprises a cylindrical storage structure (100) designed to maximize storage capacity within a minimal footprint. The cylindrical structure houses five racks (110), each capable of holding plurality of pizzas or other products in a freezer environment. The cylindrical design allows for efficient use of space and easy access to stored products.

In the same embodiment, the system is equipped with a standard LCD payment and ordering system (200). This system allows customers to select their desired product using a touchscreen interface. The ordering system is connected to a central processing unit (CPU) that manages the selection process and activates the cooking cycle based on the customer's input.

In another embodiment, the product retrieval mechanism includes a self-contained robotic fork (150) configured to grab the selected product and deliver it to an oven (310). Upon selection, the designated multi-channel rack (110) is positioned under an opening (120) that leads to the upper cooking and serving section (300). A flap in the upper cooking and serving section (300) opens, and the multi-channel rack is lifted through the opening by a lifting mechanism.

In a further embodiment, the oven (310) is configured to cook the product using a combination of microwave, impingement and infrared heating methods. The oven includes a defrosting cycle to prepare the product before applying intense heat. The microwave, impingement heating method involves directing hot air at high velocity onto the product, while the infrared heating method uses radiant heat to cook the product evenly and quickly. This combination ensures that the product is cooked to a quality comparable to commercially prepared pizzas.

In yet another embodiment, the product delivery mechanism comprises a serving tray mechanism (330) and a delivery conveyor (320). After the cooking cycle, the robotic fork (150) extracts the cooked product from the oven (310) and moves it towards the delivery conveyor (320). The serving tray mechanism drops a serving tray onto the delivery conveyor before the robotic fork places the hot product into the tray. The delivery conveyor is then activated, moving the ready product towards the front delivery window (340).

In an additional embodiment, the front delivery window (340) features a mechanical platform that rises to present the finished product to the customer. The delivery platform retracts after the product is retrieved, and the access door (360) closes to maintain the internal environment of the system. The delivery window is designed to open and close automatically, ensuring a seamless and hygienic delivery process.

In another preferred embodiment, the system is designed for easy loading and maintenance. Parbaked products can be loaded into the system through an opening (370) in the front. The serving plate attachment (380) can be detached, filled, and reattached with minimal effort. The use of simple mechanical movements and readily available robotic components ensures that the system is easy to service and maintain.

In one embodiment, the invention addresses the complexity and mechanical failures associated with existing pizza dispensing machines by implementing a simplified design. The use of a robotic arm (150) eliminates the need for complex servos and programmable logic controllers (PLCs), reducing replacement costs and downtime.

In another embodiment, the cylindrical design (100) and nesting format of the pans (110) allow for maximum product storage within a minimal footprint. This design eliminates the need for cumbersome product coverings, reducing associated costs and additional components.

In a further embodiment, the combination of microwave, impingement and infrared heating methods ensures that the product is cooked evenly and quickly. The robotic fork (150) and delivery conveyor system (320) streamline the process of moving the product from the oven (310) to the customer, ensuring a quick and efficient delivery.

In yet another embodiment, the standard LCD payment and ordering system (200) provides a user-friendly interface for customers, making the ordering process simple and efficient. The system is designed to handle multiple transactions seamlessly, ensuring a positive customer experience.

In an additional embodiment, by leveraging simple mechanical movements and readily available robotic components, the invention minimizes the need for complex and expensive parts. This results in a cost-effective and reliable solution for dispensing high-quality pizzas.

In one embodiment, the customer selects the desired product using the LCD payment and ordering system (200). The CPU (210) processes the selection and activates the cooking cycle. The designated multi-channel rack (110) is positioned under the opening (120) in the upper section (300). The lifting mechanism (140) raises the multi-channel rack, and the flap (130) opens to allow the multi-channel rack to pass through. The robotic fork (150) grabs the selected product and delivers it to the oven (310). The oven (310) defrosts the product and then cooks it using microwave, impingement and infrared heating methods. The combination of these methods ensures even and quick cooking. The robotic fork (150) extracts the cooked product from the oven (310) and places it onto the delivery conveyor (320). The serving tray mechanism (330) drops a serving tray onto the conveyor before the product is placed into the tray. The delivery conveyor moves the product towards the front delivery window (340). The mechanical platform (350) at the front delivery window (340) rises to present the product to the customer. The platform retracts after the product is retrieved, and the access door (360) closes to maintain the internal environment of the system. Parbaked products are loaded into the system through the front opening (370). The serving plate attachment (380) can be detached, filled, and reattached with minimal effort, ensuring easy maintenance.

The present invention offers a significant improvement over existing pizza dispensing machines by addressing the challenges of complexity, mechanical failures, and high manufacturing costs. The simplified design, combined with advanced robotic technology, ensures that the system is easy to service and maintain while delivering high-quality pizzas quickly and efficiently. The innovative features and advantages of the invention make it a reliable and cost-effective solution for automated pizza dispensing.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiments chosen for illustration without departing from the spirit and scope of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Having fully and clearly described the invention so as to enable one having skill in the art to understand and practice the same, the invention claimed is:

1. An automated pizza dispensing system, comprising:
a cylindrical storage structure housing a plurality of multi-channel racks, each rack capable of holding a plurality of pizzas or other products in a freezer environment;
a standard LCD payment and ordering system configured to allow a customer to select a product and activate a cooking cycle;
a product retrieval mechanism comprising a self-contained robotic fork configured to grab the selected product and deliver it to an oven;
an oven configured to cook the product using microwave, impingement, infrared heating, or a combination thereof;
a delivery mechanism comprising a serving tray mechanism and a delivery conveyor configured to transfer the cooked product to a front delivery window;
a front delivery window with a mechanical platform configured to present the cooked product to the customer.

2. The automated pizza dispensing system of claim 1, wherein the cylindrical storage structure comprises at least five multi-channel racks, each capable of holding plurality of pizzas or other products.

3. The automated pizza dispensing system of claim 1, wherein the product retrieval mechanism is configured to lift the selected multi-channel rack through an opening in the upper section of the system.

4. The automated pizza dispensing system of claim 1, wherein the oven is configured to go through a defrosting cycle before applying intense heat to cook the product.

5. The automated pizza dispensing system of claim 1, wherein the delivery mechanism further comprises a robotic fork configured to extract the cooked product from the oven and place it onto the delivery conveyor.

6. The automated pizza dispensing system of claim 1, wherein the serving tray mechanism is configured to drop a serving tray onto the delivery conveyor before the robotic fork places the cooked product into the tray.

7. The automated pizza dispensing system of claim 1, wherein the front delivery window is configured to open and close automatically to present the cooked product to the customer and maintain the internal environment of the system.

8. The automated pizza dispensing system of claim 1, further comprising a loading mechanism configured to allow parbaked products to be loaded into the system through an opening in the front.

9. The automated pizza dispensing system of claim 1, wherein the serving plate attachment is detachable, fillable, and reattachable with minimal effort.

10. The automated pizza dispensing system of claim 1, wherein the cylindrical design and nesting format of the pans eliminate the need for product coverings, reducing associated costs and additional components.

11. The automated pizza dispensing system of claim 1, wherein the robotic fork follows a preset path to deliver the product to the oven and extract the cooked product from the oven.

12. The automated pizza dispensing system of claim 1, wherein the oven uses a combination of microwave, impingement and infrared heating methods to ensure even and quick cooking of the product.

13. The automated pizza dispensing system of claim 1, wherein the delivery conveyor is activated to move the ready product towards the front delivery window after the robotic fork places the cooked product into the serving tray.

14. A method for dispensing pizzas using an automated pizza dispensing system, comprising:
receiving a product selection from a customer via a standard LCD payment and ordering system;
activating a cooking cycle based on the product selection;
positioning a selected multi-channel rack under an opening in the upper section of the system;
lifting the selected multi-channel rack through the opening;
grabbing the selected product with a self-contained robotic fork and delivering it to an oven;
cooking the product using microwave, impingement, infrared heating, or a combination thereof;
extracting the cooked product from the oven with the robotic fork and placing it onto a delivery conveyor;
dropping a serving tray onto the delivery conveyor before placing the cooked product into the tray;
transferring the cooked product to a front delivery window using the delivery conveyor;
presenting the cooked product to the customer via a mechanical platform at the front delivery window.

15. The method of claim 14, further comprising defrosting the product in the oven before applying intense heat to cook the product.

16. The method of claim 14, further comprising automatically opening and closing the front delivery window to present the cooked product to the customer and maintain the internal environment of the system.

17. The method of claim 14, further comprising loading parbaked products into the system through an opening in the front.

18. The method of claim 14, further comprising detaching, filling, and reattaching the serving plate attachment with minimal effort.

19. The method of claim 14, wherein the robotic fork follows a preset path to deliver the product to the oven and extract the cooked product from the oven.

20. The method of claim 14, wherein the oven uses a combination of microwave, impingement and infrared heating methods to ensure even and quick cooking of the product.

21. The method of claim 14, wherein the delivery conveyor is activated to move the ready product towards the front delivery window after the robotic fork places the cooked product into the serving tray.
